(19) United States
(12) Patent Application Publication
(10) Pub. No.: US 2023/0280364 A1
(43) Pub. Date: Sep. 7, 2023

(54) NON-CONTACT DISPENSERS AND RELATED METHODS

(71) Applicant: ILLUMINA, INC., San Diego, CA (US)

(72) Inventors: Xuance Zhou, Milpitas, CA (US); Reto Schoch, Danville, CA (US)

(21) Appl. No.: 18/177,946

(22) Filed: Mar. 3, 2023

Related U.S. Application Data
(60) Provisional application No. 63/316,715, filed on Mar. 4, 2022.

(51) Int. Cl. G01N 35/10

(52) U.S. Cl. CPC G01N 35/1002; G01N 35/1016

(57) ABSTRACT

Non-contact dispensers and related methods are disclosed. In an implementation, an apparatus includes a plate receptacle, a reagent reservoir receptacle, and a non-contact dispenser. The reagent reservoir receptacle receives a reagent reservoir containing reagent and the non-contact dispenser includes an inlet, an upstream valve, a syringe pump, a downstream valve, and an outlet. The syringe pump has a barrel and a hollow plunger movably disposed within the barrel. A flow path is defined between the inlet and the outlet and through the upstream valve, the barrel, the hollow plunger, and the downstream valve. The barrel is fluidically between the upstream valve and the downstream valve. The plate receptacle is to receive a well plate having a well and the non-contact dispenser is to dispense the reagent from the reagent reservoir into the well of the plate.

### RELATED APPLICATION

This application claims the benefit of and priority to U.S. Provisional Patent Application No. 63/316,715, filed Mar. 4, 2022, the content of which is incorporated by reference herein in its entirety and for all purposes.

### BACKGROUND

DNA libraries may be prepared using work flows to allow samples to be sequenced. Contact dispensers such as pipettes are often used in such work flows.

### SUMMARY

Shortcomings of the prior art can be overcome and benefits as described later in this disclosure can be achieved through the provision of non-contact dispensers and related methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

In a first implementation, an apparatus having a plate receptacle, a reagent reservoir receptacle, and a non-contact dispenser. The reagent reservoir receptacle to receive a reagent reservoir containing reagent and the non-contact dispenser includes an inlet, an upstream valve, a syringe pump, a downstream valve, and an outlet. The syringe pump has a barrel and a hollow plunger movably disposed within the barrel. A flow path is defined between the inlet and the outlet and through the upstream valve, the barrel, the hollow plunger, and the downstream valve. The barrel is fluidically between the upstream valve and the downstream valve. The plate receptacle is to receive a well plate having a well and the non-contact dispenser is to dispense the reagent from the reagent reservoir into the well of the plate.

In a second implementation, an apparatus includes an inlet, an upstream valve, a syringe pump, a downstream valve, and an outlet. The syringe pump has a barrel and a hollow plunger movably disposed within the barrel. A flow path is defined between the inlet and the outlet and through the upstream valve, the barrel, the hollow plunger, and the downstream valve. The barrel is fluidically between the upstream valve and the downstream valve.

In a third implementation, a method includes positioning an upstream valve of a non-contact dispenser in an open position, positioning a downstream valve of the non-contact dispenser in a closed position, and flowing reagent into an inlet of the non-contact dispenser and through the upstream valve and a hollow plunger of a syringe pump.

In a third implementation, an apparatus includes a non-contact dispenser having a syringe pump having a barrel and a hollow plunger movably disposed within the barrel.

In further accordance with the foregoing the first, second, third, and/or fourth implementations, an apparatus and/or method may further include or comprise any one or more of the following:

In an implementation, the apparatus includes an actuator to actuate the hollow plunger.

In another implementation, the non-contact dispenser includes a nozzle that includes the outlet.

In another implementation, the apparatus includes a fluidic line coupled to the upstream valve and the hollow plunger.

In another implementation, the hollow plunger includes an upstream facing fitting and the fluidic line is coupled to the upstream facing fitting.

In another implementation, the upstream valve and the downstream valve each include diaphragm valves having a diaphragm.

In another implementation, each of the diaphragm valves has a valve seat and an internal curved surface that define a space between the valve seat and the internal curved surface to allow movement of the diaphragm of the corresponding diaphragm valve.

In another implementation, the upstream valve has a first aperture to allow a pressure to be applied to the diaphragm of the upstream valve to actuate the upstream valve and the downstream valve defines a second aperture to allow a pressure to be applied to the diaphragm of the downstream valve to actuate the downstream valve.

In another implementation, the apparatus includes a pressure source coupled to an actuation port of the upstream valve and an actuation port of the downstream valve.

In another implementation, the apparatus includes a pressure source to actuate the upstream valve and the downstream valve.

In another implementation, the hollow plunger carries a seal and the barrel has an interior surface that the seal sealingly engages.

In another implementation, the seal includes Teflon.

In another implementation, the hollow plunger carries a pair of spaced apart seals and the barrel has an interior surface that the seals sealingly engage.

In another implementation, the apparatus includes a shaft coupled to the hollow plunger and having an end.

In another implementation, the apparatus includes an actuator to interface with the end to actuate the hollow plunger.

In another implementation, the shaft has the end defining a groove and the actuator has a gripper assembly having arms that are movable between a closed position and an open position. The arms to be received within the groove of the shaft to couple the actuator and the shaft.

In another implementation, the end of the shaft including the groove forms a knob.

In another implementation, the gripper assembly has a spring positioned between the arms to bias the arms toward the closed position.

In another implementation, the apparatus includes a shaft coupled to the hollow plunger and extending from the barrel.

In another implementation, the shaft defines a side opening. The apparatus includes a fluidic line coupled to the upstream valve, passing through the side opening, and coupled to the hollow plunger.

In another implementation, the shaft has a side fitting defining a port and a passage. The flow path is defined through the side fitting and the passage. The apparatus further includes a fluidic line coupled to the upstream valve and the side fitting.

In another implementation, the hollow plunger is self-sealing.

In another implementation, the hollow plunger has an outwardly tapered internal surface.

In another implementation, the method includes filling a barrel of the syringe pump with the reagent.

In another implementation, the method includes moving the hollow plunger away from an outlet of the non-contact dispenser while filling the barrel of the syringe pump with the reagent.

In another implementation, moving the hollow plunger away from the outlet of the non-contact dispenser includes moving the hollow plunger using a force of the reagent.

In another implementation, moving the hollow plunger away from the outlet of the non-contact dispenser includes moving the hollow plunger using an actuator.

In another implementation, the method includes positioning the upstream valve in a closed position, positioning the downstream valve in an open position, and moving the hollow plunger toward an outlet of the non-contact dispenser to dispense the reagent from the outlet.

In another implementation, the method includes positioning the upstream valve in an open position and dispensing the reagent from an outlet of the non-contact dispenser.

In another implementation, the method includes flowing a wash buffer through the non-contact dispenser.

In another implementation, the method includes flowing a second reagent through the non-contact dispenser.

In another implementation, flowing the second reagent through the non-contact dispenser includes opening the downstream valve, opening the upstream valve, and dispensing the second reagent from an outlet of the non-contact dispenser.

In another implementation, flowing the second reagent through the non-contact dispenser includes the downstream valve and the upstream valve being in an open position.

In another implementation, flowing the second reagent through the non-contact dispenser includes positioning the upstream valve in an open position, positioning the downstream valve in an open position, and moving the hollow plunger toward an outlet of the non-contact dispenser to dispense the second reagent from the outlet.

In another implementation, flowing the second reagent through the non-contact dispenser includes positioning the upstream valve of the non-contact dispenser in the open position, positioning the downstream valve of the non-contact dispenser in the closed position, and flowing the second reagent into the inlet of the non-contact dispenser and through the upstream valve and the hollow plunger of the syringe pump.

In another implementation, the method includes positioning the upstream valve of the non-contact dispenser in the open position, positioning the downstream valve of the non-contact dispenser in the closed position, and flowing a second reagent into the inlet of the non-contact dispenser and through the upstream valve and the hollow plunger of the syringe pump.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect described herein. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a cross-sectional schematic diagram of an implementation of a non-contact dispenser that can be used to implement the non-contact dispenser of FIG. 1.

FIG. 3 is a side view of an implementation of a non-contact dispenser that can be used to implement the non-contact dispenser of FIG. 1 and an actuator that can be used to implement the actuator of FIG. 1.

FIG. 4 is a partial cross-sectional view of the non-contact dispenser of FIG. 3 with the knob removed from the shaft.

FIG. 5 is a detailed view of the non-contact dispenser of FIG. 3 showing the outwardly tapered internal surface of the hollow plunger and the coupling between the fluidic line and the upward facing fitting of the hollow plunger.

FIG. 6 is a partial cross-sectional view of another non-contact dispenser that can be used to implement the non-contact dispenser of FIG. 1.

FIG. 7 illustrates a flowchart describing a process for a using the non-contact dispenser or any of the other implementations disclosed herein.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

At least one aspect of this disclosure is related to systems that automate library preparation processes, sample preparation processes, or other similar processes, and use less consumables, thereby reducing a footprint of the system and an amount of solid waste produced. The systems disclosed use a non-contact dispenser(s) that has an inline and relatively straight fluid path that reduces the presence of corners, allows the non-contact dispensers to be easily flushed, and reduces manufacturing complexity. The non-contact dispensers can switch between dispensing different reagents as a result using the same non-contact dispenser without those reagents adversely interacting with one another. Dead volume of reagent is also reduced using the disclosed implementations.

Some non-contact dispensers disclosed have an inlet, an upstream valve, a syringe pump, a downstream valve, and an outlet. The syringe pump includes a barrel and a hollow plunger movably disposed within the barrel. A flow path is defined between the inlet and the outlet and through the upstream valve, the barrel, the hollow plunger, and the downstream valve. The flow path passing through hollow plunger allows the flow path to be relatively straight and for the non-contact dispenser to be easily flushed.

The non-contact dispenser can be used to dispense smaller volumes of reagent with high accuracy by positioning the upstream valve in an open position, positioning the downstream valve in a closed position, and flowing reagent into the inlet of the non-contact dispenser and through the upstream valve and the hollow plunger of the syringe pump. The barrel of the syringe pump is filled with the reagent as the hollow plunger is moved away from the outlet of the non-contact dispenser. The reagent is dispensed from the non-contact dispenser in some implementations by positioning the upstream valve in a closed position, positioning the downstream valve in an open position, and moving the hollow plunger toward the outlet of the non-contact dispenser. The non-contact dispenser can be used to dispense larger volumes of reagent with high accuracy by positioning both the upstream valve and the downstream valve in the open position. Wash buffer may be used to flush the non-contact dispenser before switching between reagents.

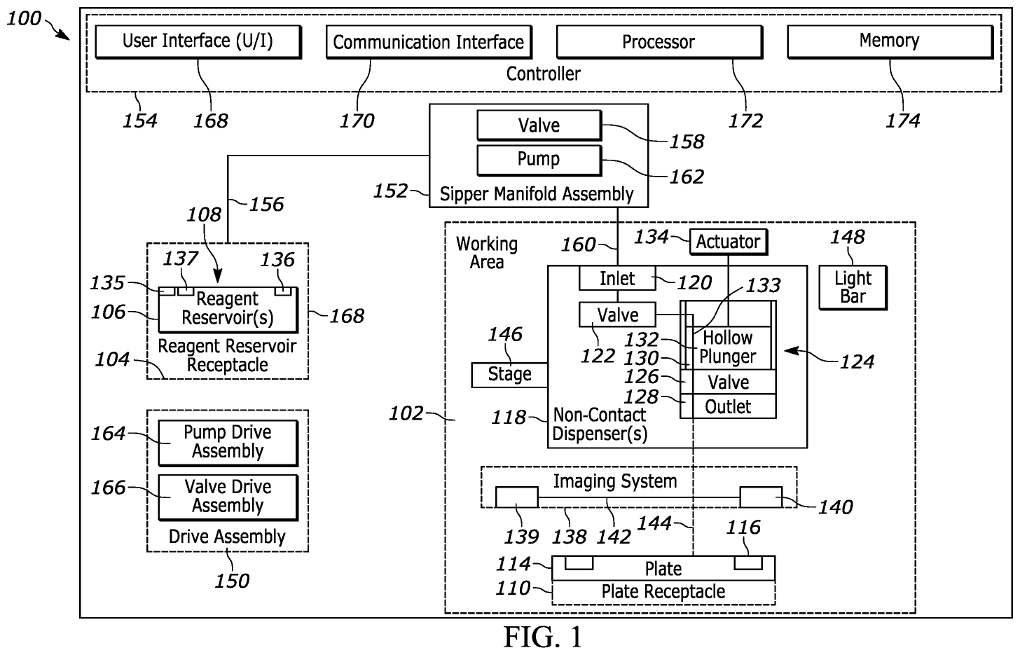

FIG. 1 illustrates a schematic diagram of an implementation of a system 100 in accordance with the teachings of this disclosure. The system 100 may be used to automatically, easily, and efficiently prepare DNA libraries for sequencing applications, for example. The system 100 may perform DNA library preparation workflows that include amplification processes, cleanup processes, library normalization processes, and/or pooling processes in some implementations. The system 100 may perform workflows such as whole genome sequencing (WGS) workflows, DNA & RNA enrichment workflows, methylation workflows, split-pool amplicon workflows, and/or amplicon workflows, among others. The DNA library preparation workflow can be performed on any number of samples such as between one sample and twenty-four samples, forty-eight samples, ninety-six samples, or more. The system 100 thus allows for variable batch processing. Other uses of the system 100 may prove suitable, however. The system 100 includes a working area 102 and a reagent reservoir receptacle 104 to receive a reagent reservoir 106 containing reagent 108 in the implementation shown. The reagent reservoir receptacle 104 may alternatively be positioned above the working area 102.

The working area 102 includes a plate receptacle 110 that receives a plate 114 having a well 116 and a non-contact dispenser 118 that dispenses the reagent 108 from the reagent reservoir 103 into the well 116 of the plate 114. The plate 114 may have any number of wells 116 such as twenty-four wells. Another number of wells 116 is suitable, however.

The non-contact dispenser 118 is fluidly coupled to the reagent reservoir 106. The non-contact dispenser 118 may alternatively aspirate reagent 108 from the reagent reservoir 106 using tips, for example, and dispense the reagent 108 into the wells 116 of the plate 114. The non-contact dispenser 118 may not be fluidly coupled to the reagent reservoir 106 in such implementations.

The non-contact dispenser 118 has an inlet 120, an upstream valve 122, a syringe pump 124, a downstream valve 126, and an outlet 128. The syringe pump 124 includes a barrel 130 and a hollow plunger 132 movably disposed within the barrel 130. A flow path 133 is defined between the inlet 120 and the outlet 128 and through the upstream valve 122, the barrel 130, the hollow plunger 132, and the downstream valve 126. The flow path 133 shown is inline and relatively straight and, thus, has limited or no corners and/or areas that inhibit flushing. The non-contact dispenser 118 may be easily flushed and/or cleaned as a result. The barrel 130 is fluidically positioned between the upstream valve 122 and the downstream valve 126. The system 100 also includes an actuator 134 that actuates the hollow plunger 132. The actuator 134 may be a voice coil. Other types of actuators 134 are suitable, however.

The non-contact dispenser 118 can be used to dispense smaller volumes of the reagent 108 and larger volumes of the reagent 108. Wash buffer 136 may flush the non-contact dispenser 118 to allow the non-contact dispenser 118 to dispense different reagents 108.

The non-contact dispenser 118 can dispense a smaller volume of the first reagent 135 by positioning the upstream valve 122 in an open position to fill the non-contact dispenser 118 with a first reagent 135 while the downstream valve 126 is in the closed position. The first reagent 135 flows into the inlet 120 and through the upstream valve 122 and the hollow plunger 132 and the reagent 108 fills the barrel 130. The hollow plunger 132 is moved away from the outlet 128 while the barrel 130 is filled with the reagent 108. The first reagent 135 can exert a force that acts on the hollow plunger 132 that moves the hollow plunger 132 away from the outlet 128 of the non-contact dispenser 118. The hollow plunger 132 can additionally or alternatively be moved away from the outlet 128 using the actuator 134.

The upstream valve 122 is in a closed position when dispensing the smaller volumes of the reagent 108; the downstream valve 126 is in an open position, and the hollow plunger 132 moves toward the outlet 128 of the non-contact dispenser 118. The non-contact dispenser 118 can dispense a larger volume of the first reagent 135 by positioning both the upstream valve 122 and the downstream valve 126 in the open position and flowing the first reagent 135 into the inlet 120 and through the upstream valve 122, the hollow plunger 132, and out of the outlet 128. The hollow plunger 132 may be in a lowered position when the non-contact dispenser 118 dispenses larger volumes. The hollow plunger 132 may be in other positions, however.

The non-contact dispenser 118 may flow the wash buffer 136 through the non-contact dispenser to flush the first reagent 135 out of the non-contact dispenser 118 to allow the non-contact dispenser 118 to dispense a second reagent 137 through the non-contact dispenser 118. The non-contact dispenser 118 can thus dispense any number of reagents for any library prep workflow and can be flushed/cleaned before switching between reagents. The non-contact dispenser 118 can also be used to dispense fluid for other reasons including those not associated with library prep workflows.

The working area 102 also includes an imaging system 138 that can be used to determine a volume of the reagent 108 dispensed from the non-contact dispenser 118. The imaging system 138 includes a light source assembly 139 and an imaging device 140 in the implementation shown. The light source assembly 139 generates a beam 142 of illumination in operation that is directed toward the imaging device 140 and through a dispensing path 144 of the non-contact dispenser 118. The beam 142 may, thus, encounter and/or be affected by the reagent 108 being dispensed. The imaging device 140 obtains image data associated with the dispensed reagent 118 and the system 100 uses the image data to determine and/or verify a volume of the reagent 108 dispensed. The imaging system 138 may alternatively be omitted.

The working area includes a stage 146 that is used to move the non-contact dispenser 118 relative to the plate receptacle 110 and a light bar 148 that may be used to degrade oligonucleotides. The stage 146 may be an X-Y stage or an X-Y-Z stage. The light bar 148 may be a high power ultraviolet light (UV) light bar that is regularly used throughout a workflow to repeatedly degrade oligonucleotides to deter cross contamination in some implementations.

The system 100 also includes a drive assembly 150, a sipper manifold assembly 152, and a controller 154. The sipper manifold assembly 152 may be coupled to a corresponding number of the reagent reservoirs 106 via reagent sippers 156. The reagent reservoir 106 may contain fluid (e.g., reagent and/or another reaction component such as the reagents 135, 138 or the wash buffer 136). The sipper manifold assembly 152 includes a plurality of ports in some implementations where each port of the sipper manifold assembly 152 may receive one of the reagent sippers 156. The reagent sippers 156 may be referred to as fluidic lines. The sipper manifold assembly 152 also includes a valve 158 that may be selectively actuated to control the flow of fluid through a fluidic line 160. The sipper manifold assembly 152 also includes a pump 162 to selectively flow the reagent(s) 108 from the reagent reservoir 106, through the reagent sipper 156, through the fluidic line 160, and out of the non-contact dispenser 118.

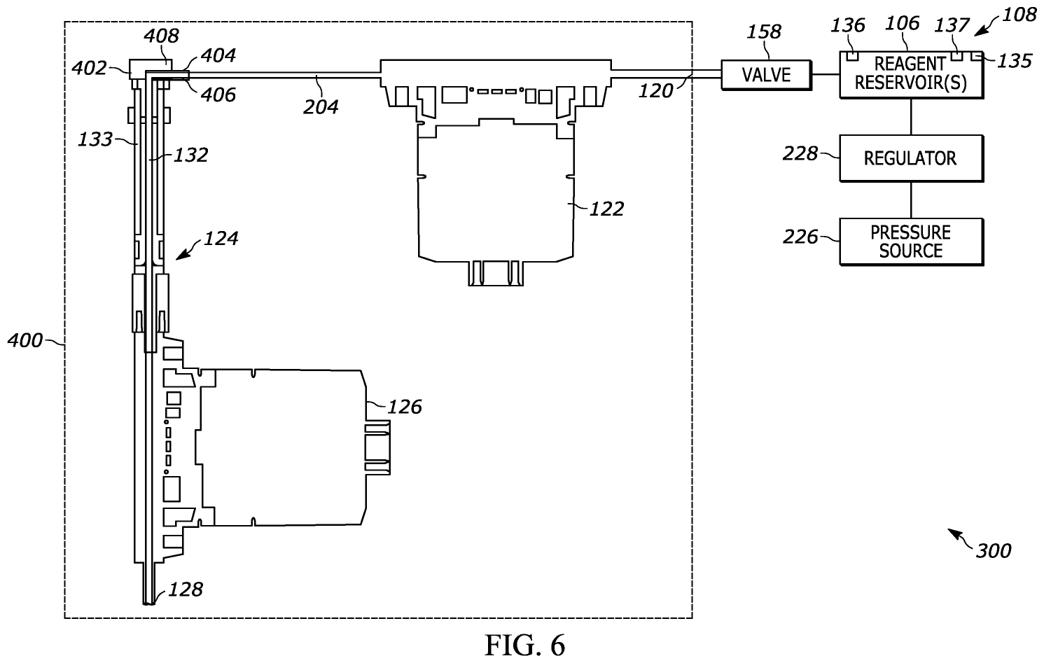

The valve 158 may be implemented by a rotary valve, a selector valve, a pinch valve, a flat valve, a solenoid valve, a check valve, a piezo valve, etc. Other fluid control devices may prove suitable. The pump 162 may be implemented by a syringe pump, a peristaltic pump, and/or a diaphragm pump. Other types of fluid transfer devices may be used, however. The controller 54 is electrically and/or communicatively coupled to the non-contact dispenser 118, the actuator 134, the imaging system 138, the light bar 148, the drive assembly 150, and the sipper manifold assembly 152 to perform various functions as disclosed herein. The sipper manifold assembly 152 may alternatively be omitted or modified. The reagent 108 may be urged from the reagent reservoir 106 using positive pressure and the pump 187 may be omitted, for example (See, FIG. 6).

The drive assembly 150 includes a pump drive assembly 164 and a valve drive assembly 166. The pump drive assembly 164 may be adapted to interface with the pump 162 to pump fluid from the reagent reservoir 106 to the non-contact dispenser 118. The valve drive assembly 166 may be adapted to interface with the valves 122, 126, 158 to control the position of the valves 122, 126, 158.

The controller 154 includes a user interface 168, a communication interface 170, one or more processors 172, and a memory 174 storing instructions executable by the one or more processors 172 to perform various functions including the disclosed implementations. The user interface 168, the communication interface 170, and the memory 174 are electrically and/or communicatively coupled to the one or more processors 172.

In an implementation, the user interface 168 receives input from a user and provides information to the user associated with the operation of the system 100 and/or an analysis taking place. The user interface 168 may include a touch screen, a display, a keyboard, a speaker(s), a mouse, a track ball, and/or a voice recognition system. The touch screen and/or the display may display a graphical user interface (GUI).

In an implementation, the communication interface 170 enables communication between the system 100 and a remote system(s) (e.g., computers) using a network(s). The network(s) may include an intranet, a local-area network (LAN), a wide-area network (WAN), the internet, etc. Some of the communications provided to the remote system may be associated with a dispensing process(es), an amplification process(es), a cleanup process(es), a library normalization process(es), and/or a pooling process(es)), etc. generated or otherwise obtained by the system 100. Some of the communications provided to the system 100 may be associated with a dispensing process(es), an amplification process(es), a cleanup process(es), a library normalization process(es), and/or a pooling process(es) to be executed by the system 100.

The one or more processors 172 and/or the system 100 may include one or more of a processor-based system(s) or a microprocessor-based system(s). In some implementations, the one or more processors 172 and/or the system 100 includes a reduced-instruction set computer(s) (RISC), an application specific integrated circuit(s) (ASICs), a field programmable gate array(s) (FPGAs), a field programmable logic device(s) (FPLD(s)), a logic circuit(s), and/or another logic-based device executing various functions including the ones described herein.

The memory 174 can include one or more of a hard disk drive, a flash memory, a read-only memory (ROM), erasable programmable read-only memory (EPROM), electrically erasable programmable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

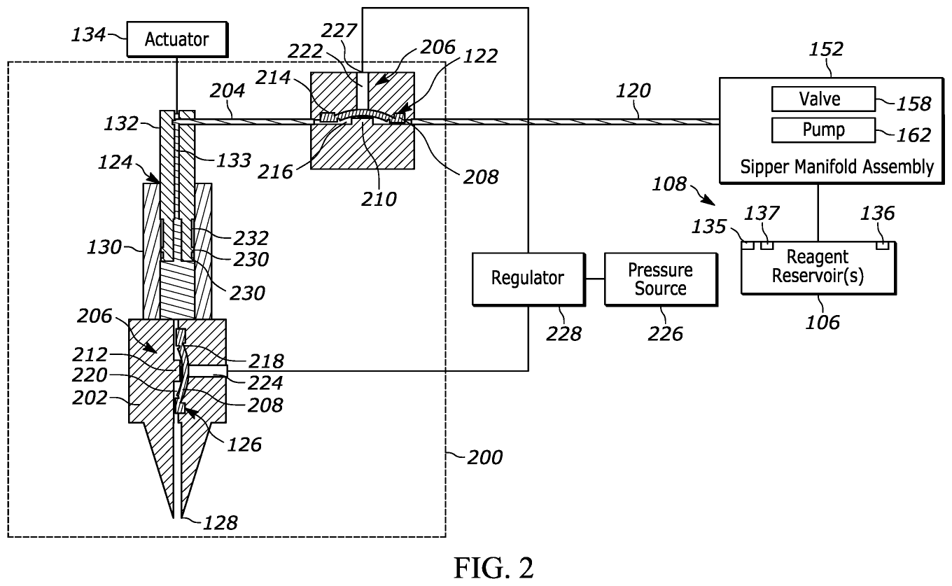

FIG. 2 is a cross-sectional schematic diagram of an implementation of a non-contact dispenser 200 that can be used to implement the non-contact dispenser 118 of FIG. 1. The non-contact dispenser 200 of FIG. 2 includes the inlet 120, the upstream valve 122, the syringe pump 124 including the barrel 130 and the hollow plunger 132, the downstream valve 126, and the outlet 128. The non-contact dispenser 200 of FIG. 2 also has a nozzle 202 including the outlet 128 and a fluidic line 204 that is coupled to the upstream valve 122 and the hollow plunger 132. The fluidic line 204 may be flexible tubing.

The upstream valve 122 and the downstream valve 126 may each be diaphragm valves 206 having a diaphragm 208. The upstream valve 122 has a valve seat 210 and the downstream valve 126 has a valve seat 212. The upstream valve 122 also has first internal curved surfaces 214 that define a first space 216 between the valve seat 210 of the upstream valve 122 and the first internal curved surfaces 214 to allow movement of the diaphragm 208 of the upstream valve 122 between the open position shown in FIG. 2 and a closed position. The downstream valve 126 similarly has second internal curved surfaces 218 that define a second space 220 between the valve seat 212 of the downstream valve 126 and the second internal curved surfaces 218 to allow movement of the diaphragm 208 of the downstream valve 126 between the open position shown in FIG. 2 and a closed position.

The upstream valve 122 defines a first aperture 222 to allow a pressure to be applied to the diaphragm 208 of the upstream valve 122 to actuate the upstream valve 122 and the downstream valve 126 defines a second aperture 224 to allow a pressure to be applied to the downstream valve 126 to actuate the downstream valve 126. A pressure source 226 is also included that is fluidically coupled to the upstream valve 122 and the downstream valve 126. The pressure source 226 may be coupled to an actuation port 227 of the upstream valve 122 and an actuation port 227 of the downstream valve 126. The pressure source 226 may be used to implement the valve drive assembly 166 and can actuate the upstream valve 122 and the downstream valve 126. A regulator 228 is positioned between the pressure source 226 and the valves 122, 126 and regulates a pressure of the gas provided to the valves 122, 126. The gas may be air, nitrogen, and/or argon. Other gases may prove suitable. The valves 122, 126 may be actuated in a different way such as using a solenoid, however.

The hollow plunger 132 is shown carrying a seal 230 and the barrel 130 has an interior surface 232 that the seal 230 sealingly engages. The seal 230 interacts with the interior surface 232 to inhibit or prevent fluid such as the reagent 108 from flowing between the seal 230 and the interior surface 232 of the barrel 130. The seal 230 may include Teflon™. The seal 230 may include additional or alternative materials, however. The hollow plunger 132 may include a pair of the seals 230 that are spaced apart and that sealingly engage the interior surface 232 of the barrel 130. Any number of seals 230 may be included, however.

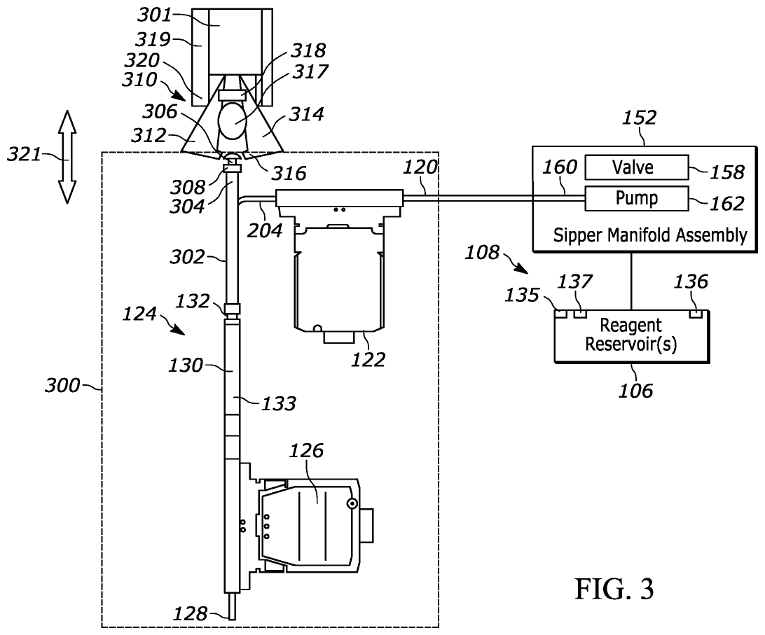

FIG. 3 is a side view of an implementation of a non-contact dispenser 300 that can be used to implement the non-contact dispenser 118 of FIG. 1 and an actuator 301 that can be used to implement the actuator 134 of FIG. 1. The non-contact dispenser 200 of FIG. 2 includes the inlet 120, the upstream valve 122, the syringe pump 124 including the barrel 130 and the hollow plunger 132, the downstream valve 126, and the outlet 128. The non-contact dispenser 200 has a shaft 302 coupled to the hollow plunger 130 and having an end 304. The shaft 302 and the hollow plunger 130, thus, move together. The actuator 301 interfaces with the end 304 of the shaft 302 to actuate the hollow plunger 130. The actuator 301 may move the end 304 toward the outlet 128 to dispense the reagent 108 from the non-contact dispenser 300 and the reagent 108 itself may move the hollow plunger 130 away from the outlet 128 when the syringe pump 124 is being filled with the reagent 108. The actuator 301 may, thus, be used to dispense the reagent 108 and may not be used when aspirating the reagent 108 into the syringe pump 124. The actuator 301 may alternatively be used to both dispense the reagent 108 and to aspirate the reagent 108 into the syringe pump 124.

The end 304 of the shaft 302 defines a groove 306 and forms a knob 308 and the actuator 301 has a gripper assembly 310 having arms 312, 314 that are movable between a closed position and an open position. The knob 308 may be removably coupled to the shaft 302. The arms 312, 314 have inward facing grippers 316 that are received within the groove 306 of the shaft 302 to couple the actuator 301 and the shaft 302. The arms 312, 314 are movable relative to a pivot 317. The gripper assembly 310 has a spring 318 positioned between the arms 312, 314 to bias the arms 312, 314 toward the closed position.

The actuator 301 is positioned within a housing 319 having a distal end 320 and is movable in a direction generally indicated by arrow 321 between a first position shown and a second position. The distal end 320 of the housing 319 engages the arms 312, 314 of the gripper assembly 310 in the first position, compresses the spring 318, and moves the arms 312, 314 to an open position. The gripper assembly 310 can be positioned about the knob 308 in the open position. The actuator 301 may extend from the distal end 320 of the housing 319 in the second position such that the arms 312, 314 of the gripper assembly 310 are spaced from the housing 319 and the spring 318 biases the arms 312, 314 into a closed position. The gripper assembly 310 can grasp the knob 308 in the closed position.

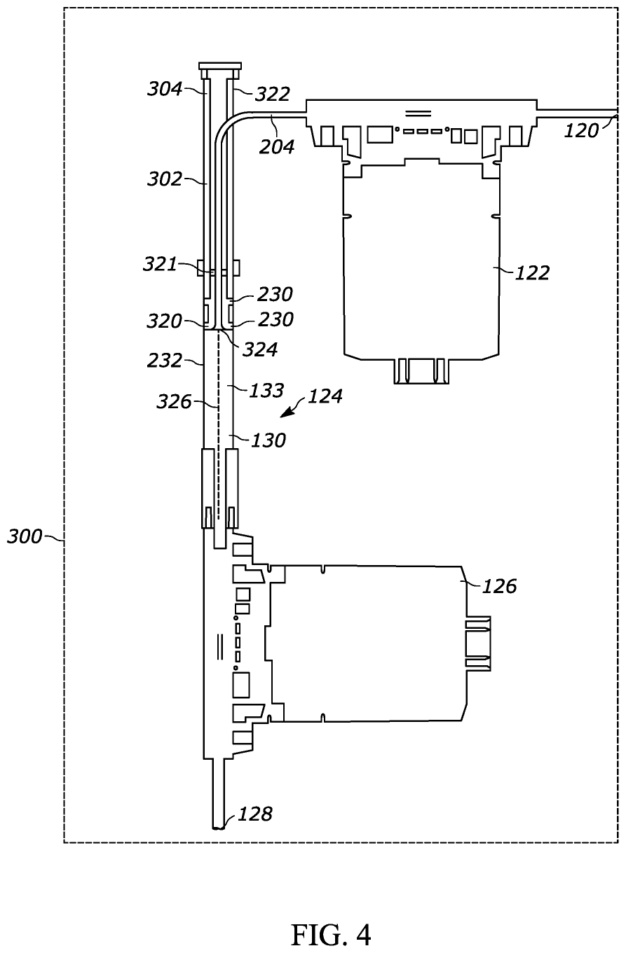

FIG. 4 is a partial cross-sectional view of the non-contact dispenser 300 of FIG. 3 with the knob 308 removed from the shaft 302. The hollow plunger 132 of the non-contact dispenser 300 has an upward facing fitting 320 and the fluidic line 204 is coupled to the upstream valve 122 and the upward facing fitting 320 of the hollow plunger 132. The shaft 302 defines a side opening 322 and the fluidic line 204 is shown passing through the side opening 322 and being coupled to the hollow plunger 132. The shaft 302 is shown as a separate component that is positioned around the hollow plunger 132. The shaft 302 may be coupled to the hollow plunger 132 by an interference fit, a fastener, and/or adhesive. The shaft 302 and the hollow plunger 132 may alternatively be formed of a single part.

The hollow plunger 132 is self-sealing in the implementation shown. The hollow plunger 132 has an outwardly tapered internal surface 324 to do so. The outwardly tapered internal surface 324 tapers away from a longitudinal axis 326 of the hollow plunger 132 and allows reagent 108 contained within the syringe pump 124 to impart a radial force on the outwardly tapered internal surface 324 that urges the hollow plunger 132 against the interior surface 232 of the barrel 130. The hollow plunger 132 interacts with the interior surface 232 in this way to form a leak seal and/or a lip seal.

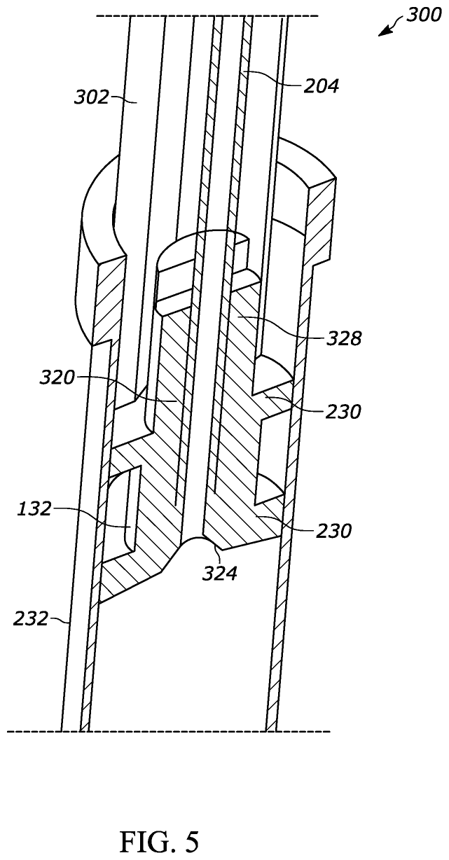

FIG. 5 is a detailed view of the non-contact dispenser 300 of FIG. 3 showing the outwardly tapered internal surface 324 of the hollow plunger 132 and the coupling between the fluidic line 204 and the upward facing fitting 320 of the hollow plunger 132. The shaft 302 is shown surrounding and being coupled to a portion 328 of the hollow plunger 132. The portion 328 may include the upward facing fitting 320.

FIG. 6 is a partial cross-sectional view of a non-contact dispenser 400 that can be used to implement the non-contact dispenser 118 of FIG. 1. The non-contact dispenser 400 of FIG. 6 is similar to the non-contact dispenser 300 of FIG. 3. The non-contact dispenser 400 of FIG. 6 in contrast includes a shaft 402 having a side fitting 404 defining a port 406 and a passage 408 that is fluidly coupled to the flow path 133. The fluidic line 204 is coupled to the upstream valve 122 and the side fitting 404. The fluidic line 204 may be coupled to the side fitting 404 instead of being coupled directly to the hollow plunger 132 when the barrel 130 has a smaller diameter and the non-contact dispenser 400 is used to dispense smaller volumes.

The pressure source 226 is shown coupled to the reagent reservoir 106 and is used to pressurize the one or more wells of the reagent reservoir 106 and/or the reagents 135, 137 and/or the wash buffer 136 contained in those wells. The fluid 135, 136, 137 may be urged toward the valve 158 and the non-contact dispenser 400 under pressure from the pressure source 226. The valve 158 may be used to select which fluid 135, 136, 137 is flowed into the non-contact dispenser 400. The regulator 228 is positioned between the pressure source 226 and the reagent reservoir 106 and regulates a pressure of the gas provided to the reagent reservoir 106.

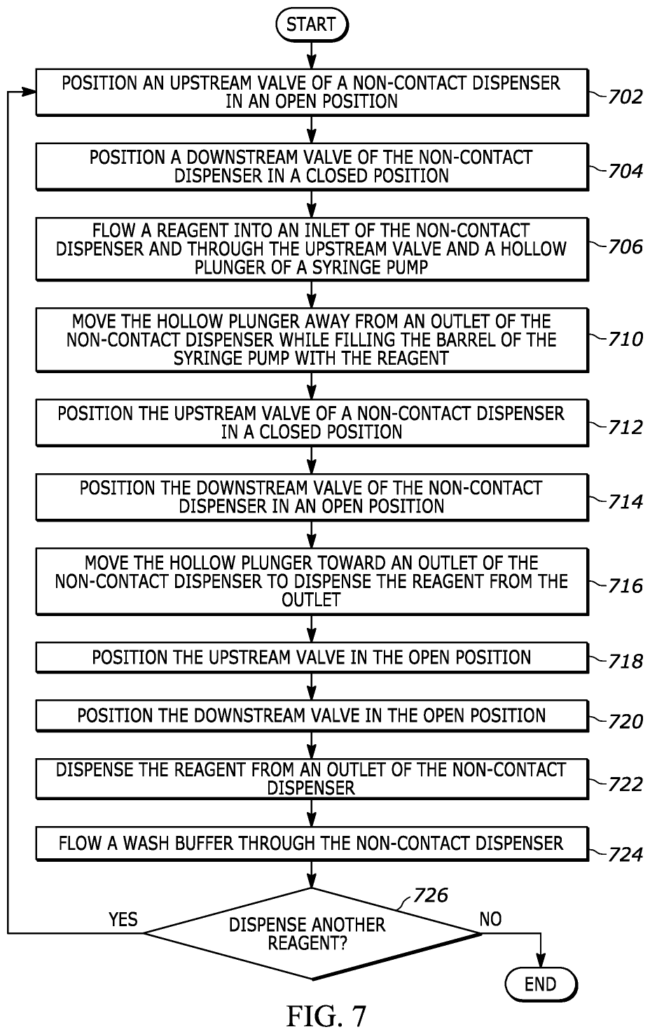

FIG. 7 illustrates a flowchart describing a process for a using the non-contact dispenser 118, 200, 300, 400 or any of the other implementations disclosed herein. The order of execution of the blocks may be changed, and/or some of the blocks described may be changed, eliminated, combined and/or subdivided into multiple blocks.

The process of FIG. 7 begins with the upstream valve 122 of the non-contact dispenser 118, 200, 300, 400 being positioned in an open position (Block 702) and the downstream valve 126 of the non-contact dispenser 118, 200, 300, 400 being positioned in a closed position (Block 704). Reagent 108 is flowed into the inlet 120 of the non-contact dispenser 118, 200, 300, 400 and through the upstream valve 122 and the hollow plunger 132 of the syringe pump 124 (Block 706). The reagent 108 may be the first reagent 135 and/or the second reagent 137. Flowing reagent 108 into the inlet 120 of the non-contact dispenser 118, 200, 300, 400 and through the upstream valve 122 and the hollow plunger 132 of the syringe pump 124 includes the barrel 130 of the syringe pump 124 being filled with the reagent 108. The hollow plunger 132 is moved away from the outlet 128 of the non-contact dispenser 118, 200, 300, 400 while the barrel 130 of the syringe pump 124 is filled with the reagent 108 (Block 710). The hollow plunger 132 can be moved away from the outlet 128 of the non-contact dispenser 118, 200, 300, 400 using a force of the reagent 108 and/or the hollow plunger 132 can be moved away from the outlet 128 of the non-contact dispenser 118, 200, 300, 400 using the actuator 134.

The upstream valve 122 of the non-contact dispenser 118, 200, 300, 400 is positioned in a closed position (Block 712) and the downstream valve 126 of the non-contact dispenser 118, 200, 300, 400 is positioned in an open position (Block 714). The hollow plunger 132 is moved toward the outlet 128 of the non-contact dispenser 118, 200, 300, 400 to dispense the reagent 108 from the outlet 128 (Block 716). The hollow plunger 132 may be moved relative to the outlet 128 of the non-contact dispenser 118, 200, 300, 400 when dispensing smaller volumes of the reagent 108.

The upstream valve 122 of the non-contact dispenser 118, 200, 300, 400 is positioned in the open position (Block 718) and the downstream valve 126 of the non-contact dispenser 118, 200, 300, 400 is positioned in the open position (Block 720). The reagent 108 is dispensed from the outlet 128 of the non-contact dispenser 118, 200, 300, 400 (Block 722). The upstream valve 122 and downstream valve 126 may be both positioned in the open position when dispensing larger volumes of the reagent 108 and the hollow plunger 132 may remain in a fixed position or a relatively fixed position and, thus, may not move when the larger volume of the reagent 108 is dispensed. The hollow plunger 132 may alternatively move when the larger volume of the reagent 108 is dispensed. The wash buffer 136 is flowed through the non-contact dispenser 118, 200, 300, 400 (Block 724). The process determines whether to dispense another reagent 108 (Block 726). The other reagent 108 may be the first reagent 135, the second reagent 137, etc. The second reagent 137 can be flowed through the non-contact dispenser 112 by opening the downstream valve 126, opening the upstream valve 122, and dispensing the second reagent 137 from the outlet 128 of the non-contact dispenser 118. The second reagent 137 can thus be flowed through the non-contact dispenser 118 by having the downstream valve 126 and the upstream valve 122 in an open position.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. In one example, these terms include situation where there is no variation −0%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a plate receptacle;
a reagent reservoir receptacle to receive a reagent reservoir containing reagent;
a non-contact dispenser, comprising:
an inlet;
an upstream valve;
a syringe pump having a barrel and a hollow plunger movably disposed within the barrel;
a downstream valve; and
an outlet;
wherein a flow path is defined between the inlet and the outlet and through the upstream valve, the barrel, the hollow plunger, and the downstream valve, the barrel being fluidically between the upstream valve and the downstream valve,
wherein the plate receptacle is to receive a well plate having a well and the non-contact dispenser is to dispense the reagent from the reagent reservoir into the well of the plate.

2. The apparatus of claim 1, further comprising an actuator to actuate the hollow plunger.

3. The apparatus of claim 1, wherein the non-contact dispenser comprises a nozzle that includes the outlet.

4. The apparatus of, further comprising a fluidic line coupled to the upstream valve and the hollow plunger.

5. The apparatus of claim 4, wherein the hollow plunger comprises an upstream facing fitting and the fluidic line is coupled to the upstream facing fitting.

6. The apparatus of claim 1, wherein the upstream valve and the downstream valve each comprise diaphragm valves having a diaphragm.

7. The apparatus of claim 6, wherein each of the diaphragm valves has a valve seat and an internal curved surface that define a space between the valve seat and the internal curved surface to allow movement of the diaphragm of the corresponding diaphragm valve.

8. The apparatus of claim 1, wherein the upstream valve comprises a first aperture to allow a pressure to be applied to the diaphragm of the upstream valve to actuate the upstream valve and the downstream valve defines a second aperture to allow a pressure to be applied to the diaphragm of the downstream valve to actuate the downstream valve.

9. The apparatus of claim 8, further comprising a pressure source coupled to an actuation port of the upstream valve and an actuation port of the downstream valve.

10. The apparatus of claim 1, wherein the hollow plunger carries a seal and the barrel comprises an interior surface that the seal sealingly engages.

11. The apparatus of claim 10, wherein the seal comprises Teflon.

12. The apparatus of claim 1, wherein the hollow plunger carries a pair of spaced apart seals and the barrel comprises an interior surface that the seals sealingly engage.

13. The apparatus of claim 1, further comprising a shaft coupled to the hollow plunger and having an end.

14. The apparatus of claim 13, further comprising an actuator to interface with the end to actuate the hollow plunger.

15. The apparatus of claim 14, wherein the shaft has the end defining a groove and the actuator has a gripper assembly having arms that are movable between a closed position and an open position, the arms to be received within the groove of the shaft to couple the actuator and the shaft.

16. The apparatus of claim 15, wherein the end of the shaft including the groove forms a knob.

17. The apparatus of claim 15, wherein the gripper assembly comprises a spring positioned between the arms to bias the arms toward the closed position.

18. An apparatus, comprising:
an inlet;
an upstream valve;
a syringe pump having a barrel and a hollow plunger movably disposed within the barrel;
a downstream valve; and
an outlet;
wherein a flow path is defined between the inlet and the outlet and through the upstream valve, the barrel, the hollow plunger, and the downstream valve, the barrel being fluidically between the upstream valve and the downstream valve.

19. The apparatus of claim 18, further comprising a shaft coupled to the hollow plunger and extending from the barrel.

20. The apparatus of claim 19, wherein the shaft defines a side opening, further comprising a fluidic line coupled to the upstream valve, passing through the side opening, and coupled to the hollow plunger.

21. The apparatus of claim 19, wherein the shaft comprises a side fitting defining a port and a passage, the flow path being defined through the side fitting and the passage, further comprising a fluidic line coupled to the upstream valve and the side fitting.

22. The apparatus of claim 18, wherein the hollow plunger is self-sealing.

23. The apparatus of claim 18, wherein the hollow plunger comprises an outwardly tapered internal surface.

24-42. (canceled)
